(19) United States
(12) Patent Application Publication
(10) Pub. No.: US 2015/0256608 A1
(43) Pub. Date: Sep. 10, 2015

(54) METHOD AND APPARATUS FOR STORING AND SHARING INFORMATION AND MULTIMEDIA CONTENT OVER THE INTERNET INCLUDING UTILIZING A PHOTO TO GAIN ACCESS TO A WEBSITE, DOMAIN OR OTHER INFORMATION OVER THE INTERNET AND UTILIZING A GEO-PLACEMENT SYSTEM TO TAG TIME, DATE AND LOCATION OF A PHOTO

(71) Applicant: BOXS, Inc., Los Gatos, CA (US)

(72) Inventors: Donald Joseph Nowell, Los Gatos, CA (US); Nicole Kathryn Young, Los Gatos, CA (US)

(21) Appl. No.: 14/641,028

(22) Filed: Mar. 6, 2015

Related U.S. Application Data
(60) Provisional application No. 61/949,830, filed on Mar. 7, 2014.

(51) Int. Cl. H04L 29/08; H04L 29/06

(52) U.S. Cl. CPC H04L 67/10; H04L 65/403; H04L 67/30

(57) ABSTRACT

A multimedia content sharing system is described herein. The multimedia content sharing system enables users to share multimedia content online easily and securely. In some embodiments, the multimedia content sharing system is able to be utilized to generate and provide an online legacy. In some embodiments, the multimedia content sharing system utilizes

PR codes and/or geotagging. In some embodiments, a private social media system is utilized in conjunction with the multimedia content sharing system.

### CROSS-REFERENCE TO RELATED APPLICATION(S)

This application claims priority under 35 U.S.C. §119(e) of the U.S. Provisional Patent Application Ser. No. 61/949,830, filed Mar. 7, 2014 and titled, “METHOD AND APPARATUS FOR STORING AND SHARING INFORMATION AND MULTIMEDIA CONTENT OVER THE INTERNET INCLUDING UTILIZING A PHOTO TO GAIN ACCESS TO A WEBSITE, DOMAIN OR OTHER INFORMATION OVER THE INTERNET AND UTILIZING A GEO-PLACEMENT SYSTEM TO TAG TIME, DATE AND LOCATION OF A PHOTO” which is hereby incorporated by reference in its entirety for all purposes.

### FIELD OF THE INVENTION

The present invention relates to the field of the Internet. More specifically, the present invention relates to sharing content via the Internet.

### BACKGROUND OF THE INVENTION

Although social networking sites such as Facebook® and Instagram® enable users to connect and share content from large distances, they continuously suffer from privacy concerns and other issues.

### SUMMARY OF THE INVENTION

A multimedia content sharing system is described herein. The multimedia content sharing system enables users to share multimedia content online easily and securely. In some embodiments, the multimedia content sharing system is able to be utilized to generate and provide an online legacy. In some embodiments, the multimedia content sharing system utilizes PR codes and/or geotagging. In some embodiments, a private social media system is utilized in conjunction with the multimedia content sharing system.

### BRIEF DESCRIPTION OF THE DRAWINGS

FIG. 1 illustrates a block diagram of a multimedia content sharing system according to some embodiments.

FIG. 2 illustrates a block diagram of a multimedia content sharing system according to some embodiments.

FIG. 3 illustrates a diagram of a PR code according to some embodiments. FIG. 4 illustrates a block diagram of an exemplary computing device configured to implement the multimedia content sharing system according to some embodiments.

FIG. 5 illustrates a flowchart of a method of multimedia content sharing according to some embodiments.

FIG. 6 illustrates a block diagram of an exemplary user interface of a sync up implementation according to some embodiments.

FIG. 7 illustrates a block diagram of an exemplary user interface of a sync up implementation according to some embodiments.

### DETAILED DESCRIPTION OF THE PREFERRED EMBODIMENT

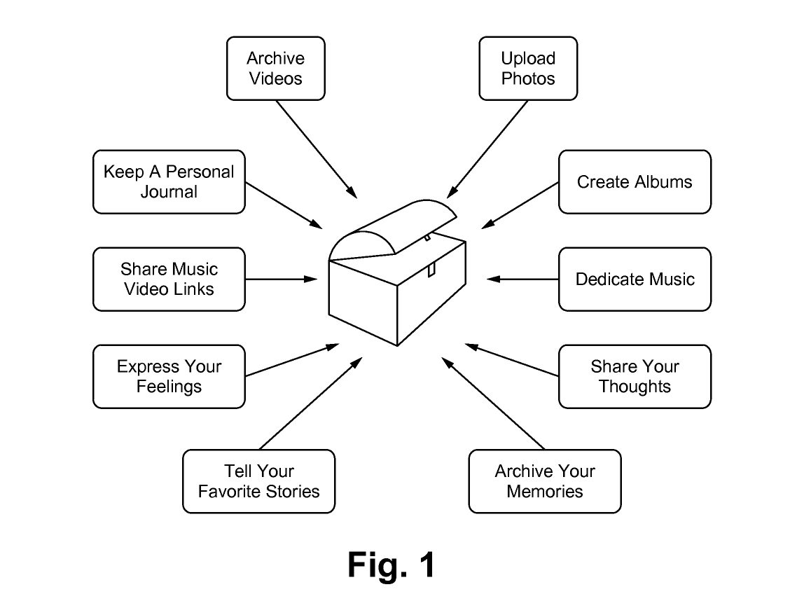

A multimedia content sharing system enables users to share multimedia content online easily and securely. The multimedia content sharing system is able to be utilized to generate and provide an online legacy. FIG. 1 illustrates a block diagram of a multimedia content sharing system according to some embodiments. Profiles are generated and shared as a gift. For example, a user generates a profile of him/herself or someone else, and then provides access to and/or the content of the profile to someone else as a gift. Furthering the example, a user generates a profile, adds content such as images, videos and text to the profile, and then gives complete access including altering capabilities to another user as a gift to that user. In some embodiments, the other user is given access upon detecting an event such as the death of the creator of the profile. Similar to a will, a beneficiary (or beneficiaries) of a profile is able to be designated. For example, upon determining that the creator has passed away, the beneficiary is given access to the profile (and does not have access before). In some embodiments, the creator is able to specify the amount of access (e.g., full, limited) which determines the capabilities of the beneficiary. In some embodiments, different beneficiaries are able to be given different levels of access (e.g., main beneficiary has full access including editing capabilities, but other beneficiaries have limited access such as viewing capabilities). Beneficiaries are able to be designated for any type of profile such as a multimedia content sharing profile or a legacy profile. In some embodiments, a profile is an archive or includes an archive. A profile is a private, password protected, internet storage module in which a user (creator) is able to place multimedia content (pictures, videos, written journals, stories, music, family trees and others) with the intention of generating the profile as a gift to be shared with one or more recipients. The recipient may or may not be able to alter the profile depending on the creator's choice. In some embodiments, an online profile is able to be copied to a flash drive or disc (or other external storage) and/ or shared as a gift to one or more recipients. The profile is able to be copied by copying a link to the external storage which links to the content stored in “the cloud,” by copying the content in the profile including any details regarding the profile, by compressing (e.g., zipping) the content and profile information, and/or any other way of copying the profile. In some embodiments, an online profile is generated as a gift for another user/recipient.

The multimedia sharing system is private interactive online space developed for families and loved ones whose relationships have been tested by distance, custody conflict, work, travel, time, deployment, or the many other circumstances that are able to lead to separation from one another. In a safe, unique, password-protected space, an individual or group is able to generate and designate a private, secure archive for another individual, group, or family to share in their personal or collective archives. Each archive is able to be filled with pictures, videos, music, stories, journal entries, and family trees while the interactive kids section offers safe, secure, parental consent “friending,” live text and video chat, as well as interactive gaming and activities. The multimedia sharing system facilitates gift-giving, educational activities, and child motivation.

The multimedia sharing system includes many features. The multimedia sharing system is able to be generated for oneself as a living life legacy, for a loved one or relative near or far, or as a memorial to the deceased. The multimedia content sharing system is password protected for both creator and recipient. The creator of the multimedia sharing profile inputs and edits content (e.g., images, videos, text). In some embodiments, the recipient may only view content (may not alter or edit content in any way). In some embodiments, the recipient may alter content. Each multimedia sharing profile is customizable by choice of many different themes. A user's multimedia sharing profile is able to be added to day after day and year after year. In some embodiments, real-time viewing of an updated multimedia content sharing profile by a recipient is implemented. For example, there is no period for moderator review; rather, as content is modified, the updated content is viewable immediately. The multimedia content profile is periodically and continuously archived online and/or saved onto a flash drive. Users are able to upload pictures, videos and music and/or other content. Users are able to write stories and include pictures or videos with the stories. Users are able to perform daily written journaling, video journaling, voice journaling or picture journaling Users are able to generate a family tree. In some embodiments, family tree generation is facilitated by analyzing other sources of data such as birth and death records and/or any other genealogical information retrievable and analyzable. Users are able to play games on the multimedia content sharing system, make friends with parental consent, interact with an online coloring book, video/text chat (with an option to record conversations with consent to save for the purpose of archiving one's past for the future).

Additionally, or in conjunction with the features described above, users are able to generate photo albums, dedicate music, share thoughts, archive memories, tell stories, express feelings, and share music and video links.

In a children's version of the multimedia content sharing system, the same or a similar platform is utilized as the multimedia content sharing system. The children's version includes a safe, secure, Coppa compliant website and children's social media. There are many features such as video chat, text chat, avatar chat, generation of clubs and groups as approved by parents, avatar builder, gaming, coloring pages, parental consent of friends and others. For example, before a (child) user is able to “connect” with another user, a parent has to confirm/approve (e.g., by entering a password) the user, and until the other user is approved by the parent, the child is not able to send messages to or receive messages from the other user.

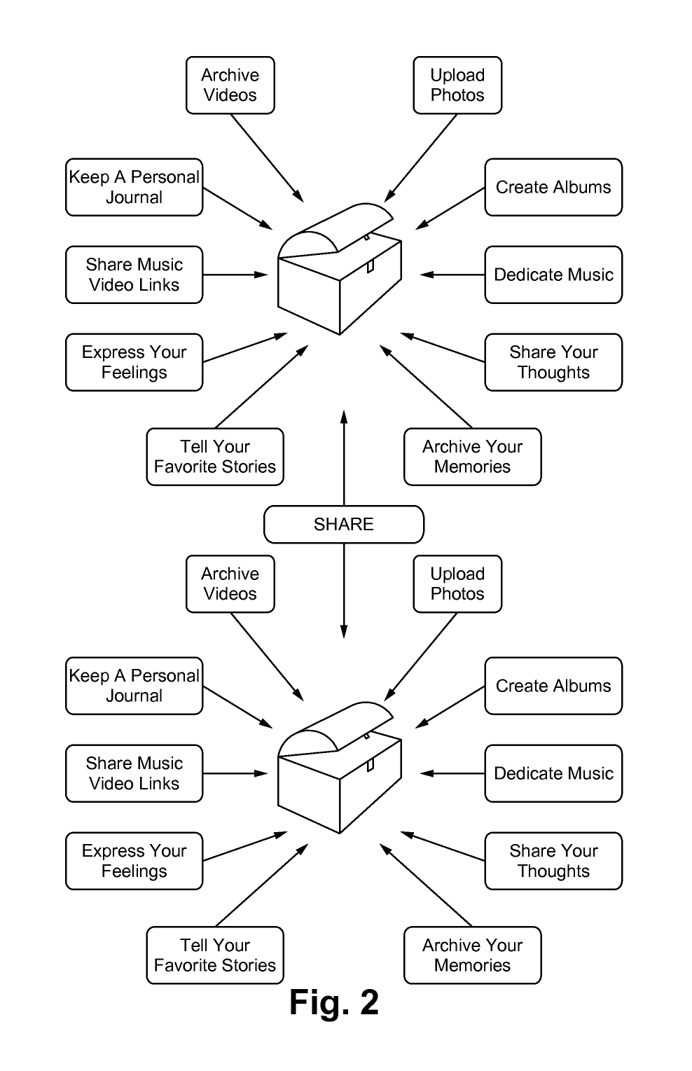

FIG. 2 illustrates a block diagram of a multimedia content sharing system according to some embodiments. After users generate their separate multimedia content sharing profiles, the users are able to share them with one another. In some embodiments, the sharing is implemented using a social networking system (e.g., select from recommended contacts), and in some embodiments, the sharing is more directly performed.

In some embodiments, an individual, family, or group is able to generate and record an archive, also referred to as a legacy profile, of their life or the life of a loved one in an elegant, personalized space that will continue to live on and be shared long after their passing. The legacy profile is similar to a multimedia content sharing profile. In contrast to other sites where it is nebulous as to what happens to a user's account when they pass away, a legacy profile implementation is specifically configured to remain active after a user's passing such that their friends, relatives, and/or other specified users are still able to access their profile. In some embodiments, a user is able to select which users are able to access the profile, and as long as those users are living, the account remains active (e.g., periodically, information about the listed users is checked to determine their living/deceased status). In some embodiments, the users designated by the user are also able to designate users, and so on, so that a user's profile is able to remain active for generations as long as one or more of the designated users designate access for future users. In some embodiments, a user is able to specify that as long as any of his/her descendants are still alive, his/her profile remains active, and those descendants are all able to access the profile. Determining access and living/deceased status are able to be performed in any manner such as by searching source information social security databases, social networking status updates, and/or any other information.

The user is able to add pictures, videos, favorite music, life stories, timelines, family trees, dreams, accomplishments, and important messages that they would like to represent them to future generations of family and friends such as a visually beautiful, peaceful, and reflective place full of life, movement, and wonder. The legacy profile is a place to generate a record of amazing accomplishments; the story of people's lives. Even after a loved one has passed away, family and friends can get together to create a memorial to honor them for generations to come. Because of the legacy profile, great, great grandchildren will have the opportunity to know the user and have a deeper understanding of where the user came from.

The legacy profile includes many features such as password protected, able to be added to day after day and year after year, archived periodically and continuously and/or save onto a flash drive or personalized external hard drive, enables users to upload pictures, videos, and other content, enables users to write stories, and include pictures or videos with the stories, enables users to speak directly, through video, to descendants, keep a journal, enables users to build a family tree and tell a life story. The legacy profile is able to be saved or passed on as an online heirloom.

The legacy profile is able to be an online multimedia storage generated by an individual or group as a memorial and lasting testimonial for an individual or individuals who are deceased, with the intention of conveying a life story to currently living individuals as well as future generations. Using pictures, music, videos, personal memorabilia, family trees and any other mixed multimedia, the generator or generators make a lasting profile that can be shared amongst family and friends, viewed and passed down for generations.

A Heritage Preservation System (HPS) is an online system using mixed multimedia to record, preserve and encapsulate one's life story. Combined with the use of the Personal Recognition Code (PR code) which links the users online legacy box with a pixelated code that is able to be scanned by a device such as a smart phone or similar device and viewed and the Footprints application, a user is able to archive, share and revisit their own life or the life of a loved one. The user decides what in their legacy profile is able to be viewed publicly with the PR code.

Footprints is an application that allows the user to tag photos and videos by location and date, onto a global map using exact map coordinates (Geo-Placement map). The Geo-tagged photos are able to be added to a legacy profile or a multimedia content shared profile and viewed as either the media itself or as a pin on a globe. The viewer of the Geo-tagged photos is able to revisit the exact spot of their ancestors, standing in their “footprints”.

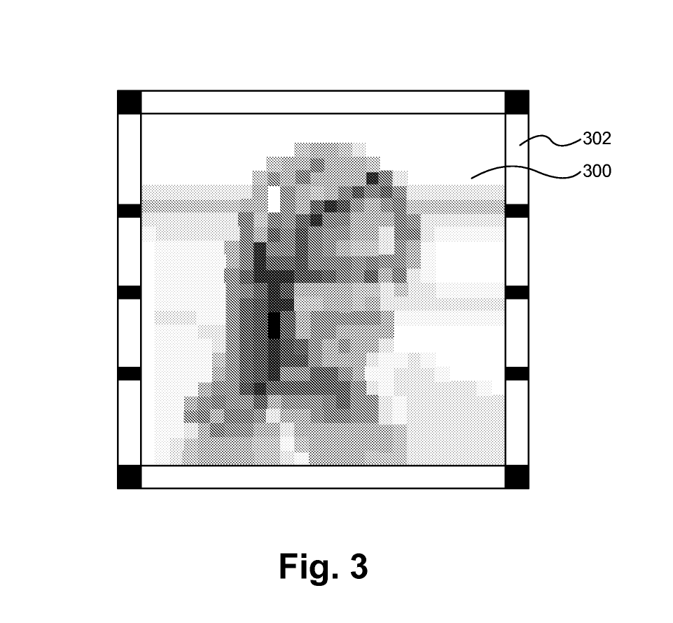

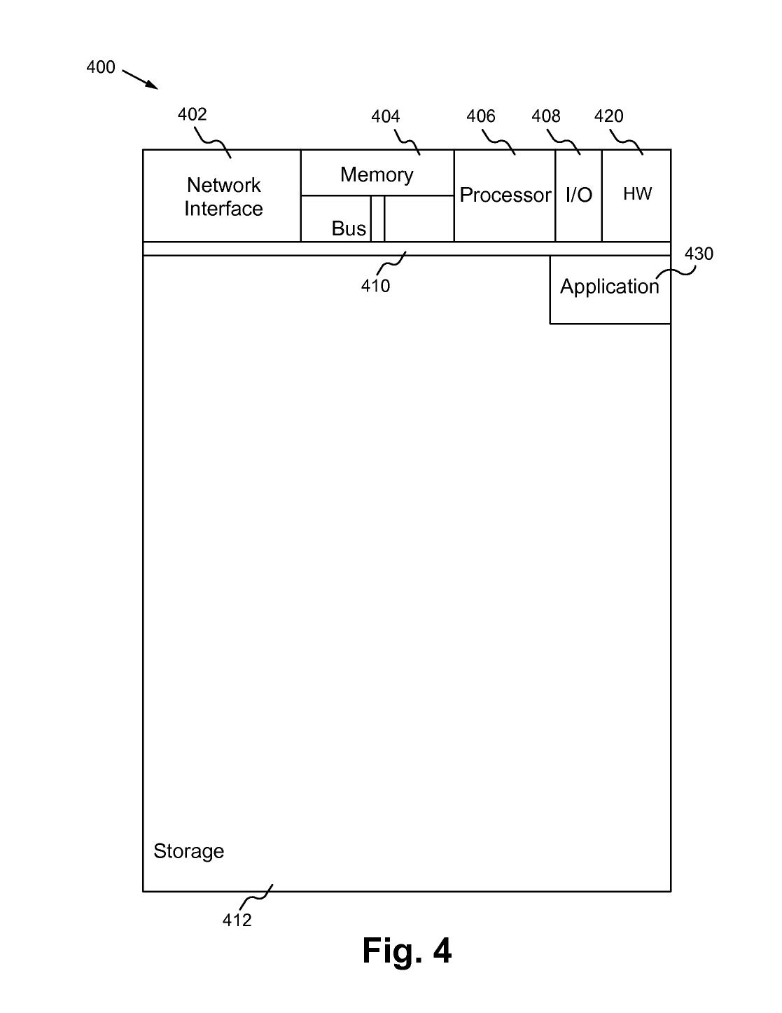

FIG. 3 illustrates a diagram of a PR code according to some embodiments. The PR code is a recognition code (e.g., a coded pixelated image of user's face or another picture). The PR code is able to link to any content (e.g., a multimedia content sharing profile or a legacy profile). The PR code is able to be generated in any manner. For example, a user acquires an image of his/her face (take a picture of him/herself), provides the image to an app or other software which pixelates and/or otherwise encodes the image, so that a reader app/software/device is able to scan/capture and analyze the image and access a legacy profile or multimedia content sharing profile of the user (e.g., will lead to a specific web site or domain, where the user's face (creator's picture) will appear on the screen as the link is verified). In another example, the app/software receives the user's image and generates a coded frame which is attached to the image (the image is pixelated or not). In another example, a system pixelates a personal picture and maps the pixels while designating the code within a secure database. In some embodiments, there is a second layer of security embedded within a frame of the picture that determines who has access to the specific information about the individual.

In some embodiments, a PR code includes a pixelated image 300 and a coded frame 302. In some embodiments, the pixelated image 300 is encoded and in some embodiments, the pixelated image 300 is not encoded. In some embodiments, the coded frame 302 includes information such as the online location and any code to access the linked online profile. In some embodiments, the pixelated image 300 and coded frame 302 are used in conjunction to access the online profile. For example, if someone scans the pixelated image 300 without the coded frame 302, no access is granted, and similarly, if someone scans the coded frame 302 without the pixelated image 300, no access is granted. Furthering the example, a scanner scans for a pixelated image 300 and a coded frame 302, and if the pixelated image 300 is found, a first lock is unlocked, and if the corresponding coded frame 302 is found, a second lock is unlocked, and access is granted to the online profile. In some embodiments, granting access includes automatically opening the online profile on the scanning device (e.g., smart phone) or a second device. In some embodiments, the image is only partially pixelated (e.g. only top half of the image or every other line of the image) or not pixelated at all. In some embodiments, another form of distortion is implemented such as blurring, warping, and/or color modifications.

The PR code is able to be physically generated and placed anywhere such as on a tombstone, a plaque on a tree, a park bench, a memorial pathway or anywhere. The physical PR code is able to be made of any material such as metal, glass, plastic, ceramic, stone, paper, plastic, wood, cards, brochures, magazines, other materials applicable to the type of environment the PR code will be placed, or a combination thereof. For example, a pixelated picture is printed on a metal plate and a coded frame also made of metal are joined (e.g., welded together), and are embedded within a tombstone. The picture and coded frame (although made of metal) are able to be scanned using a reader app on a device which provides access to the online profile.

In an exemplary use of a PR code, after the PR code is generated, a user places/affixes the PR code on an object (e.g., tombstone). Then, at some later date, even 100+ years after the PR code is placed on the object, the user or another user scans/captures an image of the PR code using a smart phone. An app on the smart phone is able to analyze and recognize information contained within the PR code and then display the data linked to the PR code (e.g., open a web page containing images, videos, text regarding the person for whom the PR code was made).

FIG. 4 illustrates a block diagram of an exemplary computing device configured to implement the multimedia content sharing system according to some embodiments. The computing device 400 is able to be used to acquire, store, compute, process, communicate and/or display information such as images, videos and text. For example, the computing device 400 is a user device for generating a multimedia content sharing profile and interacting with the multimedia content sharing profile. In another example, the computing device 400 is a server device for storing/maintaining the multimedia content sharing profile or legacy profile. The computing device 400 is able to perform any of the methods/steps described herein. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High

Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. Multimedia content sharing application(s) 430 used to perform the multimedia content sharing methods are likely to be stored in the storage device 412 and memory 404 and processed as applications are typically processed. More or fewer components shown in FIG. 4 are able to be included in the computing device 400. In some embodiments, multimedia content sharing hardware 420 is included. Although the computing device 400 in FIG. 4 includes applications 430 and hardware 420 for the multimedia content sharing system, the multimedia content sharing system is able to be implemented on a computing device in hardware, firmware, software or any combination thereof. For example, in some embodiments, the multimedia content sharing applications 430 are programmed in a memory and executed using a processor. In another example, in some embodiments, the multimedia content sharing hardware 420 is programmed hardware logic including gates specifically designed to implement the multimedia content sharing system.

In some embodiments, the multimedia content sharing application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, an augmented reality device, a virtual reality device, a home entertainment system, smart jewelry (e.g., smart watch) or any other suitable computing device.

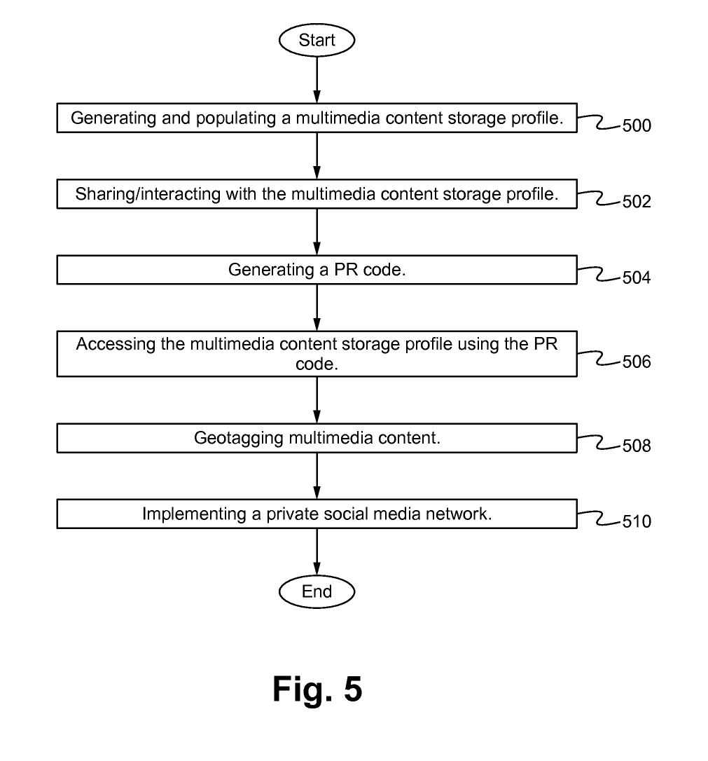

FIG. 5 illustrates a flowchart of a method of multimedia content sharing according to some embodiments. In the step 500, a multimedia content sharing profile is generated and populated. In some embodiments, instead of or in addition to generating a multimedia content sharing profile, a legacy profile is generated. Generating the multimedia content sharing profile is performed in any manner such as a user inputting in personal information (e.g., name, address, other profile information), and digital space is allocated for the multimedia content sharing profile (e.g., one or more servers allocate 1 TB of data for storage). The multimedia content sharing profile is able to be populated in any manner such as uploading images, videos and documents. In some embodiments, physical devices such as smart phones and smart cameras are able to link to the multimedia content sharing profile and automatically send content to the multimedia content sharing profile.

In the step 502, the multimedia content sharing profile is shared to other users and interacted with. Sharing is able to be implemented in any manner such as by sending an email or social networking message with access information to the multimedia content sharing profile, so that other users are able to view and/or interact with the content stored in the multimedia content sharing profile. The creator of the multimedia content sharing profile and/or other users are able to interact with the multimedia content sharing profile in any manner. The level of interactivity depends on implementations and/or access provided by the user. For example, in some embodiments, recipients are able to merely view content in the multimedia content sharing profile. In some embodiments, recipients are able to modify content and add content to the multimedia content sharing profile. The user/creator is able to add, delete, modify, and perform other actions on content in the multimedia content sharing profile.

In the step 504, a user generates a PR code. The user generates the PR code by selecting an image (e.g., taking a picture of him/herself), and providing the image to a PR code generator. The PR code generator is able to perform image modifications (in some embodiments) and generate a coded frame which includes information such as the web site address, access information, and/or other relevant information for the multimedia content sharing profile. After the PR code is generated (or at some later date such as after the user passes away), the user or another person places the PR code in a desired location (e.g., on a tombstone).

In the step 506, the multimedia content sharing profile is accessed using the PR code. A person uses a device such as a smart phone with a PR code reader (e.g., app) to scan/capture the PR code. Upon capturing the code, analysis of the code is performed to verify the code and access the correct information. For example, the code is linked to a web site address and/or login information which automatically accesses the multimedia content sharing profile. Upon proper access/verification of the code, the multimedia content sharing profile is displayed on the person's device or another device. In some embodiments, the PR code includes access information specific to another user. For example, Person A generates a multimedia content sharing profile which includes pictures and videos but also includes some extremely personal information that he only wants Persons B and C to be able to access. Encoded within the PR code is information (e.g., Person B's phone number) that when accessed by Persons B or C shows the additional personal information that is not displayed for others. Furthering the example, information (e.g., telephone number, ID number, social security number) about a user accessing the content is also analyzed/compared when the PR code is analyzed, and if the user information meets an access requirement, then additional privileges/content is made available. Furthering the example still, embedded within the PR code or accessible by the PR code is Person B's phone number, and the scanner app on Person B's phone stores Person B's phone number, and when the scanner app scans the PR code, it compares the embedded number in/accessible by the PR code with the stored number in the app and detects a match, access is granted to the additional private information. Depending on the implementation and/or access options, once the other users have access to the multimedia content sharing profile, they may be limited to viewing the content or may have other access privileges such as being able to download, share, and/or alter the content.

In the step 508, multimedia content is geotagged. Every once in awhile there is a picture that perfectly captures the moment. That moment that reflects how a user feels, or what the user is thinking or who the user is, but it goes well beyond just a normal photo album. Footprints is the specialized geo-placement system that tags the time, date and exact location of the moment. By tagging an image with specific information, a user will be able to stand in the same footprint his/her great grandfather had experienced 70 years earlier, or where the user's parents went on their first date, or the special fishing spot the user shared with his dad when he was a kid. Each time a user takes, uploads, scans or shares photos, videos, text entry with the Footprints mobile application, the content selected is placed as a pin onto a spinning 3D world globe (or other map/graphical representation) based on the exact coordinates of the content. The coordinates are able to be determined by GPS or any other coordinate determination system. In some embodiments, the device generating the content (e.g., camera taking a photo) generates the coordinates and time/date information automatically. A small icon of the photo, coordinates of the photo, video, or text entry, time, date and a creator-generated heading appear when the user's cursor is dragged over each pin. The user/creator or a viewer is able to zoom in on the globe enabling the user to easily see each individual pin and its description. The user/creator is able to write a story/description accompanying the photo, video, text entry that is able to be viewed when the pin, icon and/or description are selected (e.g., clicked)j from the globe. In some embodiments, the creator has the option to either manually enter the coordinates (latitude and longitude, city, state, country) of the photo, video or text or allow for their coordinates to be used in generating the pins location upon the globe. When the pin is chosen by the user, a new window appears, displaying that specific “event album.” Each entry displays its coordinates including name of location/country, date, time, short description and story/description. The user/creator chooses a cover photo and/or text description. In some embodiments, only the cover photo and/or text description is displayed with the pin on 3D globe world view. In some embodiments, the 3D world globe is linked to the user's multimedia content sharing profile. In some embodiments, instead of or in addition to generating the 3D world globe, the geotagged content is uploaded to the user's multimedia content sharing profile.

In the step 510, a private social media network is implemented. The social media network is able to be in addition to the multimedia content sharing system. In some embodiments, only registered members of the multimedia content sharing system are able to participate in the private social media network. The private social media network enables the user to submit posts in forums of family members and friends. Posts appear in the “Common Ground” section of the social media network. The purpose of these posts is for the forum members to be able to share and add, for example, pictures, videos, stories, family recipes with one another in order to build a balanced life history, to help to tell the complete story of one's life. Oftentimes members of a family each have individual and unique photographs and memories from the same event, or a Grandmother or Grandfather may hold a shoe box of childhood photos that the rest of their family has not yet been able to enjoy. The user is able to generate the forums so that the posts the user is sharing are appropriate for each group of relatives/friends. The user generating the post has the ability to privatize the posted matter, or allow it to be shared so that all of the family/friends within the forum can put the content into their own multimedia content sharing profiles. In some embodiments, the users of the private social network have the ability to open their multimedia content sharing profiles in pop-up windows (or other separate displays such as frames or tabs) that remain open so the user is able to easily drag content from posts from Common Ground into their existing multimedia content sharing profiles. The Common Ground is an online space designed for users to not only share their thoughts and multimedia, but to capture the content of those posts for the purpose of building and saving a single persons life story or an entire families heritage/past. The Common Ground is also an online space designed for users to share thoughts and multimedia posts for the purpose of creating a gift for a single individual or single individuals. In some embodiments, the posts made in Common Ground are automatically saved and archived in one or more of the user's profiles (e.g., the creator's profile).

In some embodiments, fewer or additional steps are implemented. For example, using a PR code and geotagging multimedia content are not implemented. In some embodiments, the order of the steps is modified. For example, multimedia content is geotagged and that geotagged multimedia content is uploaded to populate the multimedia content sharing profile after the profile is generated but before a PR code is generated.

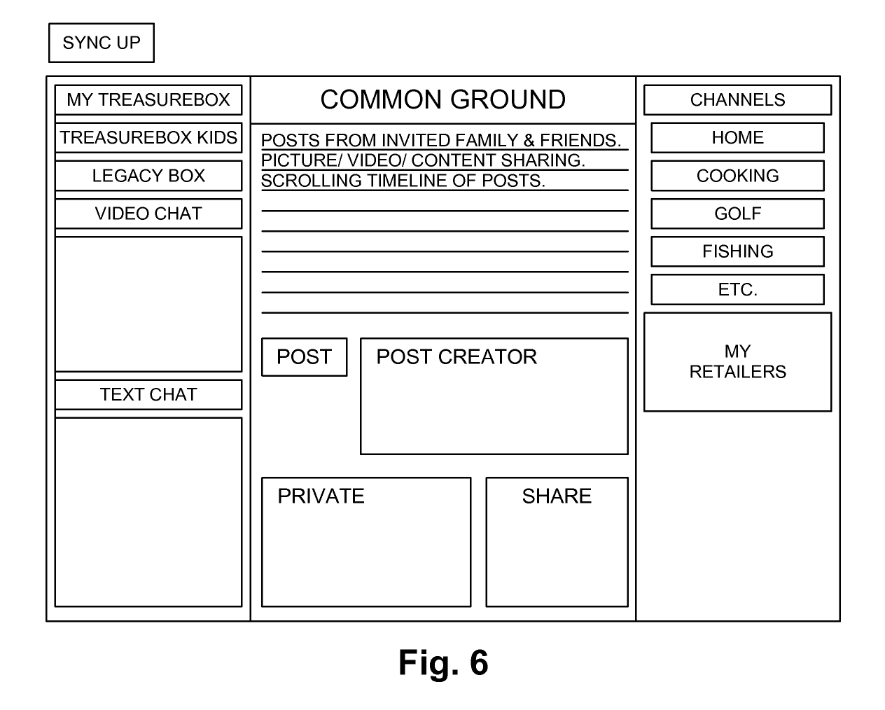

FIG. 6 illustrates a block diagram of an exemplary user interface of a sync up implementation according to some embodiments. In some embodiments, the sync up implementation is a private social media system. Included in the user interface are components to access multimedia content sharing profiles such as MyTreasureBox, TreasureBoxKids and LegacyBox. Each open in their own window, tab or frame. Multiple profiles are able to be opened at one time allowing a user to drag content from Common Ground into an opened profile (if all participants of the video chat agree). A video chat component enables video chat to be initiated which is able to be recorded and saved within a profile. Common Ground includes posts from invited family and friends, pictures, video and other content. In some embodiments, Common Ground includes a scrolling timeline of posts. Users are able to select private or share to determine which users have access to certain content. In some embodiments, channel components are included in the user interface. The channels are different categories for content such as home, cooking, golf and fishing. In some embodiments, a retailers component is also included for shopping access.

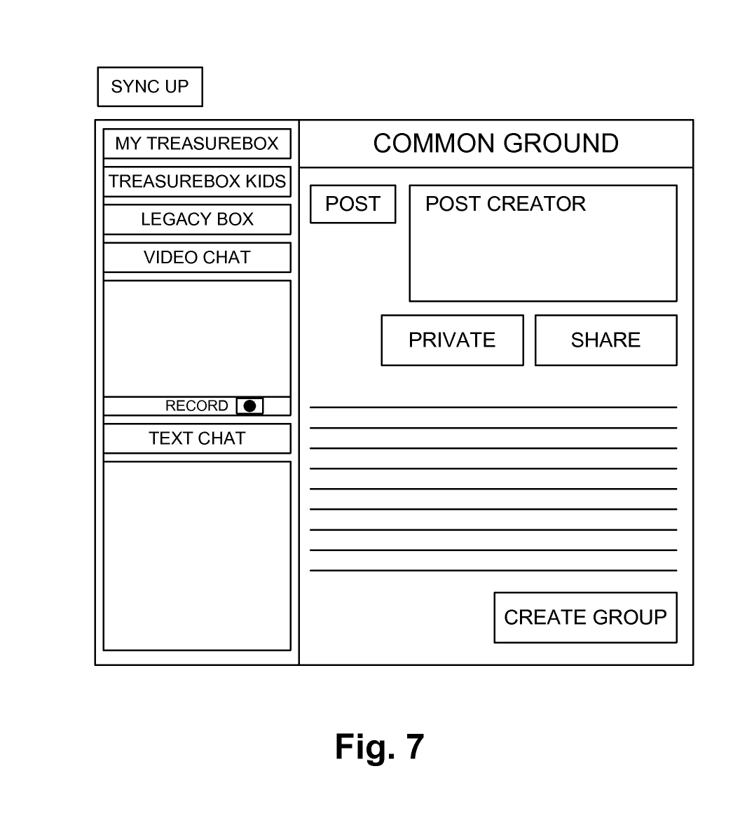

FIG. 7 illustrates a block diagram of an exemplary user interface of a sync up implementation according to some embodiments. In some embodiments, content in the multimedia content sharing profiles such as MyTreasureBox, TreasureBoxKids and LegacyBox may only be shared by the user/creator of the profile, not the recipient of the content. In some embodiments, a user is able to create groups within the Common Ground. Groups specify who the user shares specific media. Posts within groups are able to be used by the recipients to add to their profile. Users of the profiles are able to be invited into the user generated groups in order to share media between the profiles. Users are able to generate posts within groups and add content. The user/creator is able to decide whether recipients are able to share the media in their profiles or if they are only able to view the post.

To utilize the multimedia content sharing system, a user generates a multimedia content sharing profile. The user then populates the profile by uploading or otherwise adding content such as images, videos and text to the profile. The user shares the profile with others. Additional features include specialized codes for easier lookup/access to a profile and a geotagging implementation which provides location information for the content. In some embodiments, users are able to interact with the profiles using a private social network.

In operation, the multimedia content sharing system enables people from great distances and time to share memories in the form of various multimedia content. In some embodiments, the multimedia content sharing system utilizes PR codes and geotagging to provide easier lookup and detailed information regarding the content. In some embodiments, the multimedia content sharing system is implemented in conjunction with a private social network.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. generating a multimedia content sharing profile configured for online storage or downloadable to an external storage;
b. populating the multimedia content sharing profile with multimedia content, wherein the multimedia content includes geotagged information; and
c. sharing the multimedia content sharing profile with one or more recipients.

2. The method of claim 1 wherein the multimedia content sharing profile is configured to be copied to a flash drive or a disc.

3. The method of claim 1 wherein the multimedia content sharing profile includes pictures, videos, music, stories, journal entries or family trees.

4. The method of claim 1 wherein the multimedia content sharing profile is utilized on a multimedia content sharing system which is secure and utilizes parental consent friending.

5. The method of claim 1 wherein real-time viewing of the multimedia content sharing profile is implemented.

6. The method of claim 1 wherein the multimedia content sharing profile is configured to remain online after a creator of the profile passes away.

7. The method of claim 1 wherein the multimedia content sharing profile is linked with a pixelated code that is scannable by a device.

8. The method of claim 1 wherein the multimedia content sharing profile includes geo-tagged photographs.

9. The method of claim 1 wherein the multimedia content sharing profile is implemented in conjunction with a private social media system.

10. The method of claim 1 wherein the multimedia content sharing profile is provided as a gift to another user.

11. The method of claim 1 further comprising designating a beneficiary of the multimedia content sharing profile to gain access to the multimedia content sharing profile upon the death of a creator of the multimedia content sharing profile.

12. A system comprising:
a. a generating module configured for generating a multimedia content sharing profile configured for online storage or downloadable to an external storage;
b. a populating module configured for populating the multimedia content sharing profile with multimedia content, wherein the multimedia content includes geotagged information; and
c. a sharing module configured for sharing the multimedia content sharing profile with one or more recipients.

13. The system of claim 12 wherein the multimedia content sharing profile is configured to be copied to a flash drive or a disc.

14. The system of claim 12 wherein the multimedia content sharing profile includes pictures, videos, music, stories, journal entries or family trees.

15. The system of claim 12 wherein the multimedia content sharing profile is utilized on a multimedia content sharing system which is secure and utilizes parental consent friending.

16. The system of claim 12 wherein real-time viewing of the multimedia content sharing profile is implemented.

17. The system of claim 12 wherein the multimedia content sharing profile is configured to remain online after a creator of the profile passes away.

18. The system of claim 12 wherein the multimedia content sharing profile is linked with a pixelated code that is scannable by a device.

19. The system of claim 12 wherein the multimedia content sharing profile includes geo-tagged photographs.

20. The system of claim 12 wherein the multimedia content sharing profile is implemented in conjunction with a private social media system.

21. The system of claim 12 wherein the multimedia content sharing profile is provided as a gift to another user.

22. The system of claim 12 further comprising a beneficiary module configured for designating a beneficiary of the multimedia content sharing profile to gain access to the multimedia content sharing profile upon the death of a creator of the multimedia content sharing profile.

23. An apparatus comprising:
a. a non-transitory memory for storing an application, the application for:
i. generating a multimedia content sharing profile configured for online storage or downloadable to an external storage;
ii. populating the multimedia content sharing profile with multimedia content, wherein the multimedia content includes geotagged information; and
iii. sharing the multimedia content sharing profile with one or more recipients; and
b. a processing component coupled to the memory, the processing component configured for processing the application.

24. The apparatus of claim 23 wherein the multimedia content sharing profile is configured to be copied to a flash drive or a disc.

25. The apparatus of claim 23 wherein the multimedia content sharing profile includes pictures, videos, music, stories, journal entries or family trees.

26. The apparatus of claim 23 wherein the multimedia content sharing profile is utilized on a multimedia content sharing system which is secure and utilizes parental consent friending.

27. The apparatus of claim 23 wherein real-time viewing of the multimedia content sharing profile is implemented.

28. The apparatus of claim 23 wherein the multimedia content sharing profile is configured to remain online after a creator of the profile passes away.

29. The apparatus of claim 23 wherein the multimedia content sharing profile is linked with a pixelated code that is scannable by a device.

30. The apparatus of claim 23 wherein the multimedia content sharing profile includes geo-tagged photographs.

31. The apparatus of claim 23 wherein the multimedia content sharing profile is implemented in conjunction with a private social media system.

32. The apparatus of claim 23 wherein the multimedia content sharing profile is provided as a gift to another user.

33. The apparatus of claim 23 wherein the application is further for designating a beneficiary of the multimedia content sharing profile to gain access to the multimedia content sharing profile upon the death of a creator of the multimedia content sharing profile.

34. A method programmed in a non-transitory memory of a device comprising:
a. acquiring an image; and
b. generating a pixelated image from the image, wherein the pixelated image links to online content; and
c. generating a coded frame for the pixelated image.

35. The method of claim 34 wherein the pixelated image is an image of a user's face.

36. The method of claim 34 wherein the coded frame indicates which users have access to the online content.

37. The method of claim 34 wherein the online content includes a multimedia content sharing profile or a legacy profile.

38. The method of claim 34 wherein the pixelated image and coded frame are able to be captured and analyzed using a mobile device.

39. The method of claim 34 further wherein the pixelated image and the coded frame are printed on a metallic plaque.
